(19) United States
(12) Patent Application Publication
(10) Pub. No.: US 2011/0191229 A1
(43) Pub. Date: Aug. 4, 2011

(54) SYSTEM AND METHOD FOR ALLOCATING ELECTRONIC TRADE ORDERS AMONG A PLURALITY OF ELECTRONIC TRADE VENUES

(75) Inventors: Hitesh Mittal, Edison, NJ (US); Ken Gleason, Brooklyn, NY (US)

(73) Assignee: ITG SOFTWARE SOLUTIONS, INC., Culver City, CA (US)

(21) Appl. No.: 12/699,421

(22) Filed: Feb. 3, 2010

(51) Int. Cl. G06Q 40/00

(52) U.S. Cl. 705/37

(57) ABSTRACT

A method and system for optimizing allocation of large block orders for a security for maximum fill rate and minimum information leakage. The invention includes a process by which a block order for a security is allocated to a number of suborders which are then submitted to various electronic trading destinations to be filled. This allocation process involves ranking the suborders on the basis of a quality measurement, calculating and assigned a liquidity expectation to each suborder, determining a maximum target execution rate for the security that will not result in market impact, assigning orders to a trade list beginning with the higher rank suborder until the sum of shares represented in the list is equal to the maximum target execution rate, allocating the suborders not assigned to the trade list, and submitting the suborders to the corresponding electronic trading destination.

### BACKGROUND OF THE INVENTION

1. Field of the Invention

The present invention relates to electronic trading of securities and other tradeable assets via electronic trading systems. More specifically, aspects of the present invention relate to systems and methods for allocating portions of electronic trade orders among a plurality of electronic trade venues in order to improve both the quantity and quality of executions achieved when transacting large block trades.

2. Description of the Related Art

Assets can be traded electronically through a number of different trade execution venues (e.g., NYSE, NASDAQ, POSIT®, broker dealers, etc.), each of which may have a variety of different characteristics. Currently, financial systems exist that assist traders with creating, managing, and routing (i.e., directing) electronic trade orders to trade execution venues.

Trading systems exist that allow institutional traders to create and maintain trade orders. For example, Order Management Systems (OMS) are known which perform a number of features including the creation and maintenance data relating to trade orders, compliance, and other investment bookkeeping functions. For example, the MacGregor Group, Inc. offers an OMS called XIP®. Execution Management Systems (EMS) are also known. EMS's are another kind of trade tool that include facilities for creating electronic trade orders and execution features that allow traders to transmit electronic trade orders to a plurality of destinations electronically.

Electronic trade routing networks exist that enable various participants in the global electronic securities trading business to send and receive trade orders to and from multiple counterparties. Such networks can be connected to a number of trade execution venues including a number of possible liquidity sources, such as algorithmic trading systems and broker dealers.

Trade orders are often transmitted to sell-side entities (e.g., broker dealers) for execution directly or via electronic trade routing networks. That is, a buy-side institutional trader may manually select a broker destination for a trade order in his or her EMS, which will then be transmitted to the designated broker destination via the network. Once a broker receives an order, it will typically use any and all means available to execute the trade order while maximizing gain to the broker.

Traders may also use algorithmic trading systems that utilize models and strategies to provide traders the best possible execution price while trying to reduce market impact. Institutional traders, i.e., buy-side traders who execute large volume orders, often employ algorithmic trading systems to slice and dice large block orders into smaller, more easily executed orders that may be transacted throughout a trading day or even over a longer period.

Some products exist called “dark pool aggregation.” The typical goal of these products has much less to do with the quality of liquidity than with simply achieving the highest fill rate possible, regardless of the implicit costs in terms of information leakage, exposure to gaming, etc. However, buy side traders desire “clean” block trading, and existing dark pool aggregators deliver little better than Direct Market Access (“DMA”) solutions: dark pool routers that spread order information to the maximum number of possible counterparties to get to fill the maximum shares filled regardless of any negative side effects.

The order allocation systems and methods of the present invention address this need by not just aggregating, but by reintegrating liquidity access. The present invention combines several key elements: direct access to internal high-quality block order flow, integrated access to a plurality of dark liquidity pools, and optimization techniques that mitigate the risks typically associated with accessing unfiltered, dark pool liquidity.

### SUMMARY OF THE INVENTION

According to an embodiment of the present invention, a computerized method is provided for allocating an electronic trade order for trading a security to various electronic trading destinations. The method includes a step of receiving an electronic order for a security. The method also includes a step of retrieving a list of all the electronic trading destinations to which the order may be sent. The method also includes a step of calculating a score for each electronic trading destination based on criteria of the electronic trading destinations and the order. The method also includes steps of compiling a subset of electronic trading destinations based on the calculated scores, dividing the order into suborders according to the calculated scores, assigning each suborder to a corresponding target electronic trading destination, and submitting each suborder to the corresponding electronic trading destination.

According to another embodiment of the present invention, an electronic trading system is provided that includes a trading client and an order allocation system. The trading client is configured to allow a trader to submit or transmit electronic trade orders to trade tradeable assets such as equities and transmits the electronic trade orders to the order allocation system via an electronic data network. The order allocation system is configured to receive an electronic trade order, to generate and place one or more suborders with one or more destinations (e.g. ATSs, ECNs, Exchanges, etc.) based on the received order. The order allocation system is further configured to optimize placement of the suborders to maximize fill or rate while at the same time minimizing information leakage.

According to aspects of the present invention, the order allocation system is configured to allocate sub-orders based on characteristics of each destination. Each destination may have different characteristics associated with them, including the nature of the counterparties/participants, the crossing rules, the nature of stocks frequently traded, etc. These different characteristics offer opportunities to optimize allocation in ways that go beyond a simple pro-rata or weighted allocation scheme where the order allocation system sends child orders to all available destinations. The order allocation system can be configured to first identify liquidity in internal high-quality block flow pools and secondly, accesses and integrates external dark pools utilizing a real-time allocation engine and active involvement with the dark pools.

According to aspects of the present invention, information leakage can be reduced by preventing orders from being routed to dark pools that route orders out or send or interact with IOIs.

According to an embodiment of the present invention, the order allocation system is further configured to access hidden liquidity at ECNs in a controlled manner to avoid supporting stocks or causing unnecessary information leakage.

According to an embodiment of the present invention, the order allocation system is further configured to incorporate anti-gaming technology that detects unusual price movements and takes appropriate action to mitigate the effects.

According to an embodiment of the present invention, the order allocation system is further configured to optimize the allocation of trades to various ATSs according to two primary principles: first, optimizing orders based on the nature of flow in a given dark pool; second, allocating only to as many dark pools as are needed to maintain fill rate.

Further features and advantages of the present invention shall be understood in view of the following description with reference to the drawing figures.

### BRIEF DESCRIPTION OF THE DRAWINGS

The accompanying drawings, which are incorporated herein and form part of the specification, illustrate various embodiments of the present invention. In the drawings, like reference numbers indicate identical or functionally similar elements.

FIG. 1. is a representative architecture block diagram illustrating an allocation laddering system according to an embodiment of the invention.

FIG. 2 is a flow diagram illustrating an exemplary process of allocation laddering according to an embodiment of the present invention.

FIG. 3 is a flow diagram illustrating a process of allocation laddering according to another embodiment of the present invention.

FIG. 4 is a flow diagram illustrating aspects of a method of allocation laddering according to an embodiment of the present invention.

### DETAILED DESCRIPTION OF THE PREFERRED EMBODIMENTS

For purposes of this application, certain terms are defined as follows:

Order means an indication to buy or trade a tradeable asset. An order may be automatic or may require conditions to be met before execution is possible. Orders are meant to include limit orders, market orders, immediate or cancel orders, hidden orders, indications of interest, and other orders or indications.

Original order and block order are used to describe the order for a large number of shares placed of a particular security at a trading system by a buy side institutional trader.

Suborder is used to describe a portion of an original order for a security for less than the original number of shares.

ATS is used to refer to an Alternative Trading System, which is defined as a trading system that is not regulated as an exchange, but is a venue for matching the buy and sell orders of its subscribers. A trading system that is not regulated as an exchange, but is a venue for matching the buy and sell orders of its subscribers. The number of available ATSs has grown rapidly with more than 40 currently being offered by various entities.

ECN is used to refer to an Electronic Communications Network. The Securities and Exchange Commission defines ECNs as electronic trading systems that automatically match buy and sell orders at specified prices. ECNs must register with the SEC as broker-dealers and are subject to Regulation ATS.

Alternative Trading Systems (ATSs) are crossing systems in which bids and asks are not displayed on any market or exchange thus reducing the likelihood that information leakage about a large order could lead to unfavorable price movement. These ATSs can be independent or operated by a variety of different types of entities including broker/dealers, consortiums, and exchanges. ATSs may have attributes, such as average trade size, which would result in a trader favoring the use of one dark pool over another under particular circumstances.

Dark pools typically relate to ATSs; however, the skilled person will understand that dark liquidity (non-displayed or “hidden”) can be found in other trade destinations such as ECNs and Exchanges (e.g., hidden orders).

Buy side institutional traders are faced with a number of challenges including extreme volatility, counterparty risk, and rapidly evolving regulatory and economic environments. Furthermore, fragmentation of the market structure has made it increasingly difficult for the institutional trader to quickly access clean block liquidity while avoiding market impact.

The present invention relates to a system and method for aggregating allocation of electronic orders for securities and other tradeable assets to a number of different trading destinations while optimizing allocation for maximum fill rate and minimum information leakage.

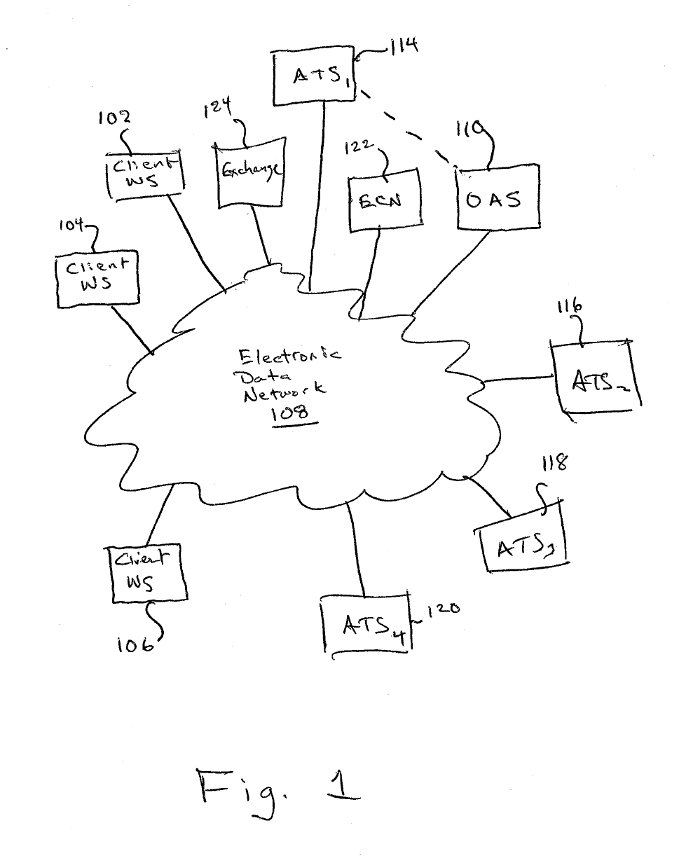

FIG. 1 is a block diagram that illustrates an exemplary representative architecture of a system according to an embodiment of the present invention. The system shown in FIG. 1 is provided solely for the sake of illustration and is not intended to limit the scope of the invention.

A trading system 100 includes client computer workstations 102, 104, 106 that may be connected to an electronic data network 108 and can be used by traders. Client computer workstations 102, 104, 106 may be configured to execute one or more trading applications for trading securities, such as an Order Management System (“OMS”), Execution Management System (“EMS”) or a specialized trade client or interface for directly accessing an order allocation system 110. Exemplary trading client applications may include ITG TRITON®, ITG RADICAL®, ITG CHANNEL®, and MACGREGOR XIP®.

The electronic data network 108 can include a local area network (LAN), wide area network (WAN), packet-switched network, the Internet, etc. The order allocation system can be made available in a variety of different ways including as a stand-alone local desktop application executing on a client computer workstation, a web-based application accessed through an internet browser, or as a component of other front end trading applications.

Order allocation system 110 may be coupled to the electronic data network 108 and with a plurality of trade destinations, including dark liquidity pools, such as, for example ATSs 114, 116, 118 and 120, ECN 122 and Exchange 124. Order allocations system 110 may be configured to received an electronic trade order (e.g., from a trader) and to generate and manage a number of electronic sub-orders which may be sent to one or more destinations, such as ATSs 114, 116, 118, and 120, based on criteria. Accordingly, the allocation system could be programmed with a particular algorithm to perform steps described herein.

In one embodiment of the present invention, electronic trade orders to buy or sell securities can be placed at client computer workstations 102, 104, 106 and transmitted via the electronic data network 108 to the order allocation system 110 according to known protocols. The order allocation system 110 can be configured to allocate the quantity (i.e., shares) of the original electronic trade order to a single destination or to divide the order into a plurality of suborders. Suborders may be of any size such that the total quantity is equal to or less than the original order. The suborders can be transmitted to the one or more destinations, which can include ATSs 114, 116, 118 internal to the firm operating the order allocation system 110 as well as external destinations, such as external ATSs 120, traditional market makers, exchanges 124, and ECNs 122. Orders are transmitted to the various ATS destinations via electronic communications network 112.

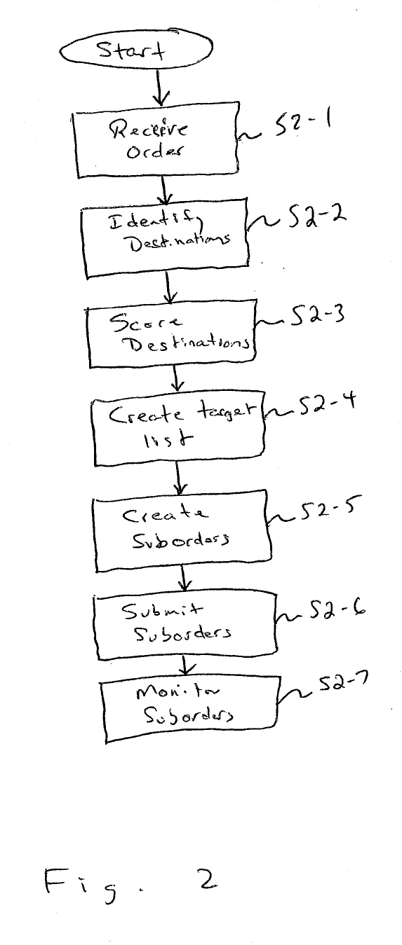

FIG. 2 illustrates the steps used in a method for allocating shares from a placed order to the various dark pool destinations according to an embodiment of the present invention. This method of this embodiment may be executed on an order allocation system 110 as described above with respect to FIG. 1.

In the first step S2-1, a block order for securities is received at an order allocation system 110. In one example, the block order was entered by an institutional trader at a client computer workstation 102, 104, 106. As described above, the block order can be entered into a variety of different applications including an OMS or EMS.

In the second step S2-2, the list of all destinations which the order might potentially be sent is retrieved by order allocation system 110, including data regarding characteristics of each destination.
a. In the third step S2-3, various destination characteristics describing each destination to which orders may be allocated along with characteristics of the original order are analyzed and a score assigned to each destination for this order. These criteria may include but are not limited to: Average Daily volume of the stock
b. Order quantity
c. Order limit price
d. Time of day
e. Current market volume
f. Current market volatility
g. Historical stock volatility.

In the fourth step S2-4, a target list of destinations to which portions of the block may be sent is compiled based on a comparison of the scores calculated in step 208, including but not limited to historical and current execution quality and liquidity, and specific features or rules of a destination that may affect performance such as the types of orders supported, minimum execution quantity support, etc. In the fifth step S2-S, the block order is subdivided into one or more suborders of differing quantity and duration for each destination on the target list. The size and type of each suborder is determined based on the score. One possible allocation for order for 10000 shares sent to four destinations with the rankings shown would be as follows:

| | | | Min Share | Duration, Order |
|---|---|---|---|---|
| Destination | Score | Quantity | Qty | Type |
| ATS1: 1 order | 1 | 5000 | | Day, Midpoint Peg |
| ATS2: 2 orders | 10 | 2000 | 400 | Day, Passive Peg |
| | | 400 | N/A | Immediate Or Cancel |
| ATS3: 2 orders | 11 | 1500 | 400 | Day, Passive Peg |
| | | 200 | N/A | Immediate or Cancel |
| ATS4: 1 order | 20 | 900 | N/A | Immediate or Cancel |

In the sixth step S2-6, each suborder is submitted to its corresponding destination determined in the previous step S2-S.

In the seventh step S2-7, the status of each submitted suborder is monitored. Parameters and limits may be placed on the suborder such that if it has not been filled in a particular timeframe or met other criteria the suborder can be cancelled. Additionally, when a suborder is filled, it may be advantageous to cancel the unfilled suborders and re-running the allocation steps of the method using the number of shares remaining from the original block order after one or more suborders has been filled.

In order to reduce information leakage, it is preferable that dark pools accessed by the order allocation system do not route orders out or send or interact with IOIs. Similarly the order allocation system is preferably configured to access hidden liquidity at ECNs in a controlled manner to avoid supporting stocks or causing unnecessary information leakage. The order allocation system may also incorporate anti-gaming technology that detects unusual price movements and takes appropriate action to mitigate the effects. Reactive anti-gaming technology is an important safeguard but is not always sufficient to provide optimal protection from gaming. The order allocation system should be configured to optimize the allocation of trades to various ATSs according to two primary principles: first, optimizing orders based on the nature of flow in a given dark pool; second, allocating only to as many dark pools as are needed to maintain fill rate.

The system and method of the present invention can customize and optimize suborders based on the nature of the flow found in each destination. The nature of the order flow within a particular destination is an important factor to consider when determining how to place portions of an order. In particular, the order allocation systems and methods of the present invention considers one or more of the nature of the flow, support for protections such as minimum share requirements, how execution occurs including price discover (e.g., midpoint vs. non-midpoint execution), etc.

For example, there are usually three types of order flow typically found in a single ATS or dark pool. One type is block/institutional orders. Depending on the nature of the pool (e.g., mixed or pure-play institutional) and the capabilities (e.g., minimum shares, peg support, etc.) orders can be customized to access only block-size liquidity.

A second type of order flow is market-bound flow. Depending again on the capabilities of each destination, additional orders may be tailored to interact with this sort of flow to maximize executions while avoiding the inherent dangers of pinging.

A third type of order flow is to market-makers. Often considered “liquidity of last resort”, market-makers tend to only be accessed when other higher-quality liquidity is unavailable. Depending again on the capabilities of each destination, additional orders may be tailored to interact with this sort of flow to maximize executions while avoiding information leakage.

Regardless of the type of liquidity sought, the present invention preferences accesses liquidity in a very specific, controlled manner, designed to take liquidity only when needed, and minimize the information leakage that occurs, often regardless of whether executions are happening or not.

There are many factors that affect the actual orders constructed to interact with each type of flow in each pool. Preferably, the size, placement and duration of the orders will be adjusted to enhance liquidity access without increasing the effective “footprint” or information leakage of the order. It is contemplated that multiple suborders may be placed to the same destination (one targeting Institutional orders and one targeting market-bound orders, for instance). Preferably, in this case, the orders would be targeting different types of orders.

Another aspect of the present invention utilizes a fundamentally different approach to allocation when seeking liquidity in external dark pools known as “allocation laddering.” The purpose of allocation laddering is the same: to optimize allocation for maximum fill rate and minimum information leakage.

Most prior dark pool aggregation systems will take an order and divide it up either pro-rata or by some weighted scheme and allocate 100% of the order to as many pools as possible to uncover and extract maximum liquidity. For example, consider the following example: a buy order for 100K shares of ABC is to be allocated to an aggregator that contains 5 destinations. This is achieved in the simplest fashion by dividing the 100K order by the number of pools, and allocating 20K shares to each pool. This works well if the characteristics of the liquidity in the ten pools (execution quality, average trade size, proportion of institutional to market-bound flow, etc.) are all uniform. In this case, the pools are essentially interchangeable allocating equally to each pool would yield acceptable results.

This is, however, seldom the case in the real market. Consider a more realistic (but still simplistic) example, where five pools have the following characteristics:

| Pool | % | % Market | % of Stock ADV | Average Trade |
|---|---|---|---|---|
| # | Institutional | Bound | traded | Size |
| 1 | 20 | 80 | 10 | 200 |
| 2 | 25 | 75 | 5 | 200 |
| 3 | 40 | 60 | 2 | 300 |
| 4 | 90 | 10 | 5 | 900 |
| 5 | 95 | 5 | 8 | 2500 |

If a buy side trader wishes to maximize fill rate and take into account execution quality, the best approach is to allocate shares unevenly across the pools 1-5. When additional factors such as the presence of market-makers and variable liquidity are added, equally allocating shares to various pools becomes even less optimal.

Also important, information leakage increases with the number of pools to which an order is exposed. While some may claim that twenty 1000-share prints in ten pools in one second are equivalent to one 20K share print in one pool, research shows that exposure to twenty counterparties leaks more information and causes more impact than a smaller number of prints, assuming the order is not complete.

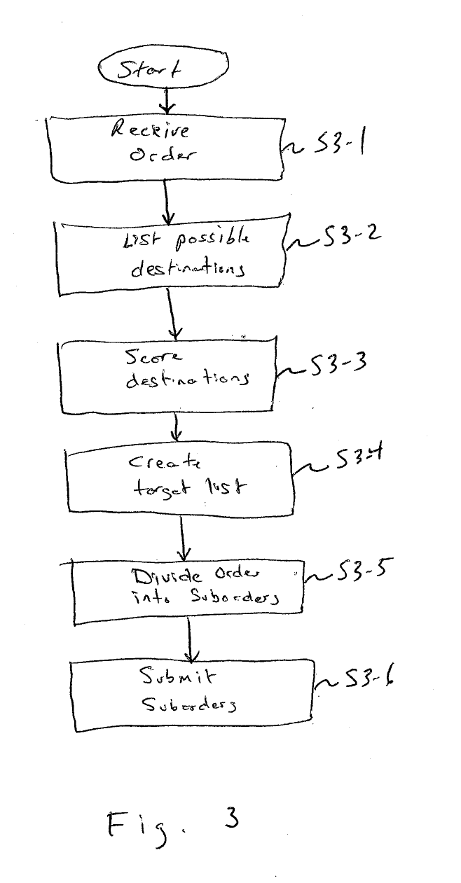

According to another aspect of the present invention, suborders are allocated to only to as many destinations as are needed to maintain an acceptable fill rate. FIG. 3 is a flow chart illustrating an exemplary process for allocating orders to destinations according to an embodiment of the present invention.

First, in step S3-1, a block order is received by the order allocation system. The block order could be a priced or unpriced order and can be received from any number of origins (e.g., trader, FIX, algorithm, etc.). Next, in step S3-2, the order allocation system obtains a list of all possible destinations which are available for trading. This list may be dynamically generated, preset or stored.

As step S3-3, the one or more “scores” are calculated based on a set of criteria. The criteria used in calculating the scores may be order specific, stock specific, customer-specific, destination specific, and/or related to the market environment or arbitrary.

At step S3-4, the calculated scores are used to create a “target list” of destinations. The target list is typically a subset of the total available destinations, although it could include all of the available destinations in some circumstances.

At step S3-S, the order allocation system divides the shares of the original order into suborders such that the sum of shares of the suborders equals the total shares of the original order. These suborders may be of different share amounts and duration. The total number of suborders will preferably be greater than or equal to the number of destinations in the target list of destinations constructed in Step S3-4.

At step S3-6, the suborders are accordingly generated and transmitted to the selected destinations.

The skilled person will understand that the order allocation system can include one or more computer server programmed to perform the foregoing steps. Further, the order allocation system may also be configured to use execution feedback data from prior allocations to help determine how to optimize subsequent allocations.

Over time, naturally, some orders will result in executions and others will not. Executions for a particular suborder to a particular pool can result in a higher expected fill rate in that pool. Likewise, a lack of fills can reduce the expected fill rate. On subsequent cycles, the order allocation system is preferably configured to re-calculate the number of shares required per destination to maintain target rates for each destination. If the desired fill rate is not being maintained, additional orders can be generated in order to ramp up to the desired fill rate. On the other hand, if the fill rate is on track or ahead, then the number of orders may be reduced.

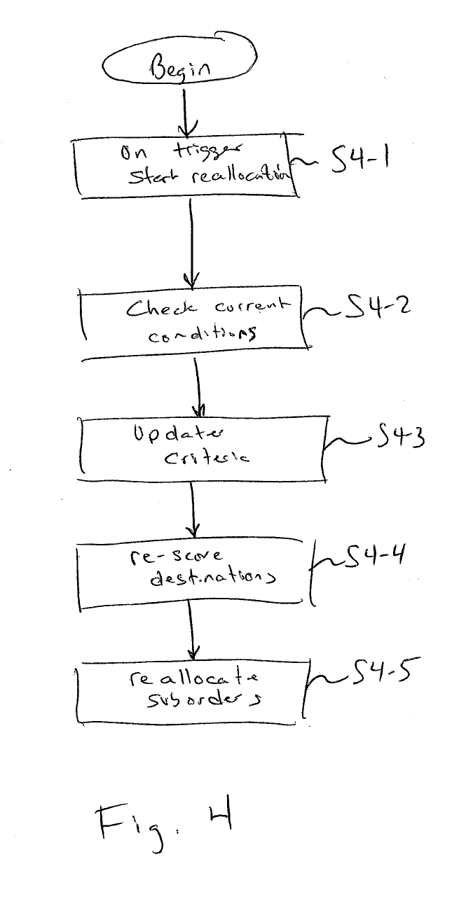

As conditions change (e.g., time elapses, suborders are being filled or not filled, stock price moves, etc.) both the values of the scores assigned to each destination and the criteria themselves may change dynamically. For example, at periodic intervals or in response to real-time events, the order allocation system will re-evaluate which criteria to enforce, resulting in a re-allocation and a change in the trading destination to which shares are allocated. FIG. 4 is an exemplary flow chart illustrating a method dynamically updating criteria according to an aspect of the present invention.

At step S4-1, a re-evaluation of a current allocation scheme is performed. For example, schedule and/or real-time event triggers could be set to initiate the re-evaluation.

At step S4-2, current conditions can be checked; the order allocation system reviews the criteria used in the current allocation scheme. The set of criteria used for destination selection may be modified depending on the results of that review.

At step S4-3, if the criteria is modified based on the review, the order allocation system can use the updated set of criteria to re-score the entire list of available destinations.

At step S4-4, based on the updated scores, a new target list is generated, which may be identical to the previous target list, or have more, less or different destinations than the previous target list.

At step S4-S, the order allocation system then compares the new target list with the previous target List. The order allocation system may then do one or more of the following actions in order to reallocate suborders such that after the allocation cycle the total sum of child order shares equals the total unfilled shares remaining in the original order:

a. Cancel suborders in ATSs from the old target list that are no longer on the new list;
b. Cancel one or suborders in an ATS while leaving other orders intact;
c. Modify the price or shares of a child order to an ATS, increasing or decreasing shares or price;
d. Send additional order(s) to an ATS that already has a child order (creation of a new child order); and
e. Send an order to ATS from the new target list that was not included in the old target list.

The order allocation system can continue this cycle until filled, cancelled, the market or markets close, or there are no available ATS to which to send an order.

Through this method, the order allocation system dynamically optimizes fill rate, execution quality and available liquidity to emphasize high-quality, institutional liquidity, and will only access lesser-quality flow when needed to maintain fill rate.

While various embodiments/variations of the present invention have been described above, it should be understood that they have been presented by way of example only, and not limitation. Thus, the breadth and scope of the present invention should not be limited by any of the above-described exemplary embodiments. Further, unless stated, none of the above embodiments are mutually exclusive. Thus, the present invention may include any combinations and/or integrations of the features of the various embodiments.

Additionally, while the processes described above and illustrated in the drawings are shown as a sequence of steps, this was done solely for the sake of illustration. Accordingly, it is contemplated that some steps may be added, some steps may be omitted, and the order of the steps may be re-arranged.

We claim:

1. A computerized method of allocating portions of an order for a security among a plurality of electronic trading systems, comprising the steps of:
receiving an electronic trade order for buying or selling a quantify of shares of a security, said order having associated to it trading criteria;
identifying a plurality of electronic trading destinations to which the order may be sent;
at a computer, calculating a score for each electronic trading destination of said plurality based on criteria for each electronic trading destination and on said trading criteria for said electronic trade order;
at a computer, determining a plurality of target electronic trading destinations based on the calculated scores, said target electronic trading destinations being a subset of said identified plurality of electronic trading destinations;
at a computer, generating a plurality of electronic order portions based on said electronic trade order and said calculated scores, the sum of the quantities of said plurality of electronic order portions being less than or equal to said quantity of shares associates with said electronic trade order;
assigning each suborder to a corresponding target electronic trading destination; and
electronically submitting each suborder to the corresponding electronic trading destination.

2. The computerized method of claim 1, wherein criteria used to calculate the score for each electronic trading destination includes trading rules for each electronic trading destination.

3. The computerized method of claim 1, wherein criteria used to calculate the score for each electronic trading destination includes information about a type of order flow transacted in said respective electronic trading destination.

4. The computerized method of claim 1, wherein the criteria used to calculate the score for each electronic trading destination includes information about trading counterparties associated with electronic trade orders in the electronic trading destination.

5. The computerized method of claim 1, wherein the criteria used to calculate the score for each electronic trading destination includes historical trading data for each electronic trading destination.

6. The computerized method of claim 1, further comprising steps of:
monitoring said order portions to determine when order portions are executed and the number of shares executed;
determining an execution rate for order portions in each target electronic trading destination; and
replacing order portions in one or more target electronic trading destination based on a comparison between determined execution rates and target execution rates.

7. The computerized method of claim 6, wherein the monitoring, determining and replace steps are repeated on a random time interval.

8. The computerized method of claim 6, wherein the monitoring, determining and replace steps are repeated on a fixed time interval.

9. The computerized method of claim 6, wherein the monitoring, determining and replace steps are repeated based after each execution.

10. A system for allocating portions of an order for a security among a plurality of electronic trading systems, comprising:
an order allocation server coupled with an electronic data network and configured to receive an electronic trade order for buying or selling a quantify of shares of a security, said order having associated to it trading criteria, to identify a plurality of electronic trading destinations to which the order may be sent, to calculate a score for each electronic trading destination of said plurality based on criteria for each electronic trading destination and on said trading criteria for said electronic trade order, to determine a plurality of target electronic trading destinations based on the calculated scores, said target electronic trading destinations being a subset of said identified plurality of electronic trading destinations, to create a plurality of electronic order portions based on said electronic trade order and said calculated scores, the sum of the quantities of said plurality of electronic order portions being less than or equal to said quantity of shares associates with said electronic trade order, to assign each suborder to a corresponding target electronic trading destination, and to electronically submitting each suborder to the corresponding electronic trading destination.

11. The system according to claim 10, wherein criteria used to calculate the score for each electronic trading destination includes trading rules for each electronic trading destination.

12. The system according to claim 10, wherein criteria used to calculate the score for each electronic trading destination includes information about a type of order flow transacted in said respective electronic trading destination.

13. The system according to claim 10, wherein the criteria used to calculate the score for each electronic trading destination includes information about trading counterparties associated with electronic trade orders in the electronic trading destination.

14. The system according to claim 10, wherein the criteria used to calculate the score for each electronic trading destination includes historical trading data for each electronic trading destination.

15. The system according to claim 10, wherein the order allocation service is further configured to monitor said order portions to determine when order portions are executed and the number of shares executed, to determine an execution rate for order portions in each target electronic trading destination, and to replace order portions in one or more target electronic trading destination based on a comparison between determined execution rates and target execution rates.

16. The system according to claim 15, wherein the monitoring, determining and replacement actions are repeated on a random time interval.

17. The system according to claim 15, wherein the monitoring, determining and replacement actions are repeated on a fixed time interval.

18. The system according to claim 15, wherein the monitoring, determining and replacement actions are repeated based after each execution.

19. A system for allocating portions of an order for a security among a plurality of electronic trading systems, comprising:
means for receiving an electronic trade order for buying or selling a quantify of shares of a security, said order having associated to it trading criteria;
means for identifying a plurality of electronic trading destinations to which the order may be sent;
means for calculating a score for each electronic trading destination of said plurality based on criteria for each electronic trading destination and on said trading criteria for said electronic trade order;
means for determining a plurality of target electronic trading destinations based on the calculated scores, said target electronic trading destinations being a subset of said identified plurality of electronic trading destinations;
means for generating a plurality of electronic order portions based on said electronic trade order and said calculated scores, the sum of the quantities of said plurality of electronic order portions being less than or equal to said quantity of shares associates with said electronic trade order;
means for assigning each suborder to a corresponding target electronic trading destination; and
means for electronically submitting each suborder to the corresponding electronic trading destination.

20. The system according to claim 19, further comprising:
means for monitoring said order portions to determine when order portions are executed and the number of shares executed;
means for determining an execution rate for order portions in each target electronic trading destination; and
means for replacing order portions in one or more target electronic trading destination based on a comparison between determined execution rates and target execution rates.
